(19) United States
(12) Patent Application Publication
(10) Pub. No.: US 2005/0249880 A1
(43) Pub. Date: Nov. 10, 2005

(54) Low VOC antimicrobial coating compositions

(76) Inventors: Angela I. Wallace, Fountain Hills, AZ (US); Joseph R. Hook, Phoenix, AZ (US); Mark S. Maroney, Cave Creek, AZ (US)

Correspondence Address: SHUGHART THOMSON & KILROY, PC, 120 WEST 12TH STREET, KANSAS CITY, MO, 64105, US

(21) Appl. No.: 11/123,538

(22) Filed: May 6, 2005

Related U.S. Application Data
(60) Provisional application No. 60/569,026, filed on May 7, 2004.

(51) Int. Cl. C08J 3/00; A23J 7/00; B05D 3/02

(52) U.S. Cl. 427/372.2; 524/800; 524/17

(57) ABSTRACT

A method of treating a substrate to seal the surface and inhibit microbiological growth using a low VOC coating composition including from about 30% to about 50% by weight of a soy methyl ester emulsion, from about 15% to about 25% by weight of a cationic acrylic resin polymer and from about 25% to about 55% by weight of water and allowing the composition to cure. The coating composition resists microbiological growth while in liquid form as well as following application and curing. The coating composition may be employed to treat architectural surfaces such as masonry and concrete and soft surfaces such as wall coverings and currency. Additives such as pigments, mineral fillers, surfactants, flattening agents and flame retardants may also be included.

### CROSS-REFERENCE TO RELATED APPLICATION

This application claims priority under 35 U.S.C. 119(e) and 37 C.F.R. 1.78(a) (4) based upon copending U.S. Provisional Application Ser. No. 60/569,026 filed May 7, 2004.

### BACKGROUND OF THE INVENTION

The present invention is broadly concerned with improved coating compositions such as protective coatings, sealers, stains and the like. More particularly, it is concerned with compositions formulated from stabilized emulsions of soy methyl esters in conjunction with a water based cationic acrylic resin to form coatings that exhibit natural antimicrobial activity both before and after curing and are low in volatile organic compounds (VOCs).

Coating compositions are commonly employed to penetrate and seal architectural surfaces against penetration by water, soil and graffiti. They are applied to floors, walls, siding, walkways, patios and decks in order to impart a durable surface coating that serves to seal and protect the underlying substrate and thereby to extend its useful life. They may also be tinted to impart a preselected decorative color.

Previously available petroleum-based compositions for coating architectural surfaces contain high concentrations of volatile organic compounds (VOCs) which are released into the atmosphere during both formulation and use. VOCs are stressful to the environment and hazardous to users. While atmospheric contamination during manufacture can be mitigated through use of commercial ventilation systems and filters, atmospheric contamination during application and curing or drying is largely unavoidable. Commercial usage of such compositions is governed by the Occupational Health and Safety Administration, which can mandate that workers wear protective equipment and that employers provide adequate ventilation at job sites. However, protective equipment such as masks and respirators is expensive, and requires upkeep such as filter replacement in order to remain effective. Even when well maintained, such equipment may be subject to failure. Noncommercial users often lack knowledge of correct protective equipment and ventilation methods for VOCs. Even if knowledgeable, they may elect to forego use of such equipment and ventilation techniques because of the expense and inconvenience involved. Accordingly, water-based compositions are generally preferred because they emit fewer VOCs.

While water-based coating compositions are generally effective at sealing substrate surfaces, they also support the growth of microbiological agents such as mold, mildew and other fungi, algae bacteria and viruses. Compositions containing acrylic resins are particularly known to support the growth of microbial agents. These agents cause deterioration of the resin coating product in the can as well as deterioration of the cured coating composition resulting in exposure of the underlying substrate. Deterioration of the coating causes disintegration of the organic matter of the substrate through exposure to the microbial agents. This disintegration may be also be enhanced by exposure to the elements. Such physical deterioration necessitates frequent recoating in order to maintain the physical integrity of the substrate.

In addition to the economic costs associated with substrate deterioration, the microbial agents that grow on deteriorated coatings and substrates are generally classified as biological pollutants. Their presence at home and in the workplace may cause health problems in humans and necessitate expensive remediation measures. In particular the black mold Stachybotrys chartarum produces mycotoxins believed to present a biohazard. Exposure to molds has been associated with health effects and symptoms such as allergic reactions, asthma and other respiratory complaints. Since all coating compositions that are exposed to the elements will eventually come in contact with microbiological agents, it is desirable that a coating composition not only seal the substrate surface, but that it act to inhibit microbiological attack as well. One method of inhibiting microbiological growth involves inclusion of biocidal additives in the formulation for such coating compositions. However, commercial biocides are generally classified as hazardous materials and require special handling. When employed in coating compositions in effective concentrations, the coating composition itself may be classified and subject to regulation as a hazardous material.

Microbiological growth is known to flourish on so called “soft” surfaces, such as fabrics and paper products. While soft surfaces such as wall coverings, fabrics and carpeting are commonly coated to resist stains and soil, the hazards associated with the use of biocidal additives generally outweigh the benefits of use. The handling of paper currency is known to present a significant means for transmission of communicable disease-causing microbiological agents. However, conventional biocides are not well-suited for use on paper currency because of the risk of hand to mouth transference and ingestion of the biocides.

Thus, there is a need for a safe, water based, low VOC coating composition for use on architectural as well as soft surfaces and that exhibits effective antimicrobial properties both in liquid form in the can and after curing without the need for incorporation of hazardous commercial biocidal additives. It is also desirable that the coating composition serve as a carrier for colorants, pigments and flame retardant compositions.

### SUMMARY OF THE INVENTION

The present invention is directed to an improved water-based coating composition incorporating a stabilized soybean oil derived base emulsion and an acrylic resin for use in preserving, sealing against water, soil and graffiti, staining, and inhibiting microbial growth on a variety of architectural and soft substrates. The compositions of the present invention are substantially organic solvent-free blends of a cationic organic resin composition and emulsified soy methyl esters, wherein the soy methyl ester serves as the primary carrier and includes an organic group or radical containing from about one to about 22 carbons in length, and preferably from about one to about 18 carbon atoms. The organic resin composition serves as the secondary carrier and may be a water based cationic acrylic resin. The combination of the soy methyl ester and the cationic acrylic resin provide resistance to microbiological growth that may also be enhanced by inclusion of small quantities of additional biocides such as fungicides and algaecides. A quantity of a colorant may be incorporated into the blend to impart a preselected hue to the coated substrate. A quantity of a tannin stain blocking additive may be included when the composition is to be applied over a wood substrate. Such compositions may be employed to seal and protect surfaces against microbiologicals, to enhance cleanability and permit removal of graffiti and to impart fire retardance.

A preferred composition of the invention is an organic solvent-free flowable liquid. Preferably the soy methyl ester emulsion is present in the composition in amounts of from about 30% to about 50% by weight, and the acrylic resin compound is incorporated in amounts of about 15% to about 25% by weight acrylic resin polymer. The remainder of the weight of the composition is made up of water and any optional additive compositions.

The coating compositions of the invention may be formulated as clear sealers, stains, pigmented paint-like coatings, and fire retardant treatments. The compositions may be applied to a wide variety of substrates such as masonry, drywall, wall coverings, metals, wood, plastics, cloth and paper products such as currency. They may also be applied to surfaces such as asphalt and the like and used for concrete curing compounds. Following application to a surface of a substrate and curing, the coating compositions of the present invention provide highly effective protection against microbiological attack from mold, mildew and other fungi, algae, bacteria and viruses.

Objects and advantages of this invention will become apparent from the following description wherein is set forth, by way of illustration and example, certain embodiments of this invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is directed to liquid compositions or admixtures of acrylic resin compounds and fatty acid alkyl esters, in particular soy methyl esters and water. Depending upon the intended usage of the coating composition, additional additive compositions may be included as well. Such additive compositions typically include colorants, surfactants, thickeners, flame retardants, and/or proprietary biocides. The compositions are used for the treatment of substrate surfaces which include, but are not limited to, masonry surfaces such as concrete, concrete block, stone, brick, tile, and associated grout, mortar and caulk; stucco, plaster, drywall and its components, mineral board, resin bonded wood panels, cloth, paper and synthetic resin, including wall coverings; fiberglass, plastics, steel, cast iron, aluminum and other metals, including ducting systems, and carbonaceous surfaces such as wood, including wooden decks and the like. The compositions can also be used in concrete curing compounds or rejuvenators and sealers for asphalt and as a mark, stain and soil-resistant treatment for cloth, carpets, currency and various other paper products.

The coating compositions of the present invention inhibit growth in the can and on the cured, coated surface of a wide variety of microbiological agents, including algae, molds, mildew and other fungi, yeasts, bacteria and viruses, including but not limited to Alternaria tenuis; Aspergillus glaucus; Aspergillus niger; Aspergillus oryzae, Aureobasidium pullulans; Candida albicans; Chaetomium globosum; Gliocladium sp; Penicillium brevicaule; Penicillium funiculosum; Saccharomyces cervisiae; Talaromyces flavus; Trichoderma viride; Algae; Chlorella pyrenoidosa; Oscillatoria sp.; Stachybotrys chartarum; Bacillus subtilis; Bacillus anthracis; Clostridium welchii; Staphylococus aureus; Escherichia coli and other coliform organisms; Streptococcus faecalis; meningococci; staphylococci; streptococci; pneumococci.

An antimicrobial coating composition for use as a clear sealer includes quantities of soy methyl ester, acrylic resin and water. The soy methyl ester serves as a plasticizer or copolymer for the acrylic resin. Soy methyl esters have the following general formula: 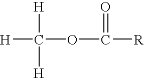
Wherein R is an organic group or radical group containing from about one to about eighteen carbons in length. It is foreseen that the R group may also contain up to about twenty two carbons in length and may contain one to three carbon-carbon double bonds. Preferably the soy methyl esters are provided in the form of a stable emulsion including a pH neutralizing composition such as 2-amino-2-methyl-1-propanol and a water reducible calcium, cobalt or zirconium drier and an anti-skin agent. The soy methyl ester emulsion is present in the composition of the invention in amounts from at least about 30% to about 50% by weight. Exemplary soy methyl ester emulsion compositions are sold under the trademark CSV3000™ by PCI Group, Inc. The soy methyl esters may also be provided in the form of pure methyl esters of soybean oil or methyl soyate. Exemplary methyl esters of soybean oil are available under the trademark SOYGOLD 2000® by AG Environmental Products, L.L.C.

Methyl esters derived from soybean oil have been found to be compatible with both petrochemical based organic resins and water based acrylic resins, although water-based acrylic resins are particularly preferred for their low VOC emissions. Because of the natural resistance of cured soy methyl esters to microbiological agents, the cured coating compositions provide extended microbiological resistance on substrates.

Virtually any acrylic resin may be employed. Exemplary resins are Specialty Polymers, Inc. RayCryl™ 708E, RayCryl™ 351C, BASF Optive 220, Rohm and Haas CS-3000™, MeadWestvaco JONREZ® IC-2815, MeadWestvaco JONREZ® IC-2959, WorleeCryl® 8721, although there are many others which are also suitable. It is also foreseen that inorganic resins such as silicates, silicones, or fluorpolymers could also be employed. Advantageously, soy methyl ester in admixture with a cationic acrylic polymer that has pendant quaternary ammonium functionality provides immediate resistance to or inhibition of microbial growth while the composition remains in liquid form in the can and prior to application of the product to a substrate and subsequent curing. An exemplary cationic water based acrylic resin are WorleeCryl® 8721 sold by Worlee-Chemie and TruDot P-2633 sold by MeadWestvaco. The water-based cationic acrylic resin composition is present in a concentration of from about 15% to about 25% by weight.

Ordinary tap water may be used in the composition, provided it does not contain excessive particulate matter, or other detrimental attributes. Water is present in a concentration of at least about 25% to about 55% by weight. It is also foreseen that the composition may be formulated to include little or no water.

It is foreseen that the composition may be formulated economically by substituting methyl esters of soybean oil, or methyl soyate for the proprietary soy methyl ester emulsion and acrylic resin solids for the acrylic resin solution. In that case, the methyl soyate will be present in the composition in amounts from about 4.35% to about 10.25% by weight and the acrylic polymer will be present in amounts of from about 15% to about 22% by weight. This composition will also include from about 0.05% to about 0.25% by weight of 2-amino-2-methyl-1-propanol and from about 1.0% to about 3.0% by weight of calcium, cobalt or zirconium water based driers. Exemplary methyl esters of soybean oil are available as Soy Gold 2000 from AG Environmental Products. An emulsifying agent in amounts of from about 0.05% to about 0.10% by weight will also be included. An exemplary emulsifying agent is Witflo® 928 from Witco.

An alternate clear sealer composition includes quantities of commercial biocides such as a fungicide and an algaecide as well as quantities of a preservative, a surfactant or leveling agent and an optional thickener. The addition of biocides exerts a synergistic effect with the natural microbiological resistance of the soy methyl esters in combination with the cationic acrylic resin and this formulation provides superior and extended inhibition of the growth of microbes, both in the can and following cure. Exemplary biocides are Troy Corporation Polyphase® 663 broad spectrum biocide, Troy Corporation Troysan® 395 broad spectrum bactericide, International Specialty Products Fungitrol® 720 fungicide and International Specialty Products Nuocide®11075 algaecide. Fungitrol® 720 is included in a concentration of about 0.07% to about 0.13% by weight. Nuocide®1075 is included in a concentration of about 0.12% to about 2.0% by weight. An exemplary preservative is Nuosept® 95 Preservative by ISP/Creanova, Inc. and it may be included in an amount of from about 0.10% to about 0.5% by weight. An exemplary surfactant is WRACLA™ by PCI Group, Inc. and it may be included in a concentration of from about 0.02% to about 0.05% by weight. An exemplary thickener is Rheolate® 288 Rheological Additive by Elementis Specialties, Inc. and it may be present in an amount of about 0.25% to about 1.0% by weight.

A second alternative embodiment for use as a stain imparting sealer includes, in addition to the previously described compositions, one or more water-based so-called machine colorants. Exemplary machine colorants are Color Corporation of America's Universal Colorants (1900 series) yellow oxide, red oxide, burnt umber and Kronos, Inc. Kronos® titanium dioxide. The relative amounts of the colorants are preselected to impart a desired stain color to the coating composition.

A third alternate paint-like protective surface coating includes, in addition to quantities of soy methyl ester, acrylic resin, water and one or more of the compositions previously described, quantities of pigments and mineral filler as well as propylene glycol, as manufactured by Lyondell, Univar USA and others, to provide a wet edge, defoamer, dispersant, and solvent. Exemplary components are Kronos, Inc. Kronos® 2020 titanium dioxide, Omya Arizona, Inc. Omyacarb® #4 calcium carbonate, Minex® mineral filler, Unimin corporation Nepheline Syenite; U.S. Zinc Corporation, zinc oxide, Colloids® 622 defoamer, Rhodoline® 226/35 Dispersant, Dow Chemical Company Triton™ CF-10 surfactant and a small quantity of solvent such as Eastman Chemical Company Texanol™ Ester Alcohol.

A fourth alternate flame retardant clear sealer includes, in addition to quantities of soy methyl ester, acrylic resin, water and one or more of the compositions previously described, quantities of a flame retardant such as Alumina Trihydrate and a flattening agent, such as TS-100 manufactured by Degussa Corporation. Other flame retardant compositions such as hexabromocyclododecane and antimony pentaoxide may also be employed. Such flame retardant compositions are particularly preferred for use as a shingle seal, wood coating, wood stain or sealer. It is foreseen that any of the formulations of the invention may also include such flame retardant compositions.

Where a coating composition in accordance with the present invention is to be used to coat a wood substrate, any of the previously described formulation may include additional quantities of a tannin stain blocking additive.

The method of forming a coating composition in accordance with the present invention includes mixing a quantity of a soy methyl ester composition with a quantity of a water-based acrylic resin and a quantity of water to form a stable homogeneous solution. A low-shear paddle mixer is preferably employed for the mixing, and the components are added gradually.

In use, the coating composition solutions may be applied to preselected substrates by brushing, rolling, spraying or dipping or by any other suitable method. Once the coating is applied to the surface, it is allowed to cure at ambient temperature, although for some substrates air drying at elevated temperatures may be employed to speed the curing process. Advantageously, microbial growth on the coated surface is inhibited and the cured coated surface is water, soil, stain and graffiti resistant. The coating seals the surface to prevent penetration of stains, soil and graffiti. Soil and stains can be easily removed by cleaning as by washing with conventional surfactant preparations. Graffiti can also be easily removed by washing with a soy solvent, such as SOYGOLD 2000®.

The coating compositions also may be applied to soft surfaces such as paper, fabrics and carpeting. The composition is applied to paper currency by first preparing a dilute solution by diluting the clear sealer composition or alternate clear sealer composition described herein 1:1 with water to achieve a 50% concentration of the initial prepared sealer composition. Those skilled in the art will appreciate that serial dilutions may be prepared and a concentration of greater or less than 50% may be selected for use depending on the nature and condition of the currency paper substrate. The dilute solution is next applied to the currency to form a coating by using jets to produce a fine mist of the solution and passing the currency through the mist. Alternatively, the currency may be placed in a rolling bath of dilute solution or it may be dipped in the solution. Rolling, brushing or any other suitable method may also be employed to achieve coating. The currency is next subject to drying to cure the composition. Drying may be at ambient temperatures, although in preferred methods the coated currency is subject to heat and forced air to speed the process. The coated currency resists microbiological growth, water, soil, stains and graffiti without loss of its customary look and feel. In the event of defacement, the currency may be wiped with a quantity of solvent to remove marks.

The following examples are for the purpose of illustrating the present invention and are not intended to be limiting upon the scope of the claims of the present application.

### EXAMPLE 1

### Clear Sealer

Soy methyl esters were mixed with acrylic resin to form a clear sealer having inherent microbial resistance.

| | |
|---|---|
| Soy Methyl Ester | 40% |
| Acrylic resin | 20% |
| H₂O | 40% |

Materials
CSV300™ Soy Methyl Ester based emulsion sold by PCI Group, Tempe, Ariz.
WorleeCryl® 8721 sold by Worlee-Chemie
Tap water

Methods

An open mixing vessel equipped with a low-shear, paddle mixer was charged with clean tap water (40.0% by weight). The mixer was initially set to about 500 revolutions per minute to create a mixing vortex. Quantities of CSV3000 T emulsion (total 40.0% by weight) and WorleeCryl® 8721 Acrylic Resin (total 20.0% by weight) were added to the vortex slowly, so as not to overwhelm or close the vortex. Upon completion of the addition, the speed of the mixer was adjusted to 1000 rpm and mixing was continued for 15 minutes until the materials were homogeneous and free of discoloration of one ingredient to the other.

### EXAMPLE 2

### Alternate Clear Sealer

Soy methyl esters were mixed with acrylic resin, fungicide, preservative and algaecide to form a clear sealer having enhanced microbial resistance.

| | |
|---|---|
| Soy Methyl Ester | 37% |
| Acrylic resin | 18% |
| Surfactant/leveling agent | 0.02% |
| biocides | 0.29% |
| preservative | 0.10% |
| thickener | 0.25% |
| H₂O | 44.34% |

Materials
CSV3000™ Soy Methyl Ester based emulsion sold by PCI Group, Inc., Tempe, Ariz.
WorleeCryl® 8721 sold by Worlee-Chemie WRACLA (Water Reducible Anti-cratering Leveling agent) Product #26 sold by PCI Group, Inc.
Fungitrol® 720 sold by International Specialty Products
Nuosept® 95 sold by International Specialty Products
Nuocide® 1075 sold by International Specialty Products
Rheolate 288 sold by Rheox, Inc.
Clean tap water

Methods

An open mixing vessel equipped with a low-shear, paddle mixer was charged with clean tap water (37% by weight). The mixer was initially set to 100-500 paddle revolutions per minute to create a mixing vortex. CSV3000™ emulsion (total 37% by weight) and WorleeCryl® 8721 (total 18% by weight) were added to the vortex slowly, so as not to overwhelm the vortex. Upon completion of the addition, the speed of the mixer was adjusted to 1000 rpm and mixing was continued for 15 minutes. WRACLA surfactant (0.02% by weight), Fungitrol® 720 (0.13% by weight), Nuosept® 95 (0.10% by weight) and Nuocide® 1075 (0.16% by weight) were premixed with 7.34% by weight of clean tap water. The resultant premix was added to the mixture vortex. The mixture was stirred at 1000 rpm for about 20 minutes. Rheolate 288 thickener (0.25% by weight) is next added to reduce the tendency of the blend from separating in the container. It is foreseen that up to about 1.0% by weight Rheolate 288 may be added, depending on the desired viscosity, which in turn may be influenced by the porosity of the surface to be coated. It is also foreseen that it may be desirable to add a quantity of a tannin stain blocking additive when the product is to be applied to the surface of a wood substrate.

### EXAMPLE 3

### Semi-Transparent Stain

Soy methyl esters were mixed with acrylic resin, fungicide, preservative and algaecide and colorants to form a penetrating stain sealer having enhanced microbial resistance.

| | |
|---|---|
| Soy methyl ester | 37% |
| Acrylic resin | 18% |
| Surfactant | 0.02% |
| Biocides | 0.29% |
| Preservative | 0.10% |
| Colorants | 6% |
| Thickener | 0.25%-1.0% |
| H₂O | 38.34% |

Materials
CSV3000™ Soy Methyl Ester based emulsion sold by PCI Group, Inc., Tempe, Ariz.
WorleeCryl® 8721 sold by Worlee-Chemie WRACLA (Water Reducible Anti-cratering Leveling agent) Product #26 sold by PCI Group, Inc.
Fungitrol® 720 sold by International Specialty Products
Nuosept® 95 sold by International Specialty Products
Nuocide® 1075 sold by International Specialty Products
Color Corporation of America's 1900 Series Machine colorant yellow oxide
Color Corporation of America's 1900 Series Machine colorant red oxide
Color Corporation of America's 1900 Series Machine colorant burnt umber
Color Corporation of America's 1900 Series Machine colorant titanium dioxide
Rheolate 288 sold by Rheox, Inc.
Clean tap water

Methods

An open mixing vessel equipped with a low-shear, paddle mixer was charged with clean tap water (37% by weight). The mixer was initially set to 100-500 paddle revolutions per minute to create a mixing vortex. CSV3000™ emulsion (total 37% by weight) and WorleeCryl® 8721 (total 18% by weight) were added to the vortex slowly, so as not to overwhelm the vortex. Upon completion of the addition, the speed of the mixer was adjusted to 1000 rpm and mixing was continued for 15 minutes. WRACLA surfactant (0.02% by weight), Fungitrol® 720 (0.13% by weight), Nuosept® 95 (0.10% by weight) and Nuocide® 1075 (0.16% by weight) were premixed with clean tap water (1.34% by weight). The resultant premix was added to the mixture vortex. The mixture was stirred at 1000 rpm for about 20 minutes. Color Corporation of America's 1900 Series Yellow Oxide (0.25% by weight), Red oxide (0.12% by weight), burnt umber (0.5% by weight) and titanium dioxide (5.13% by weight) colorants were next added to the coating composition. It is foreseen that the quantities may be varied depending upon the desired color of the stain coating. Rheolate 288 (0.25% by weight) is next added to reduce the tendency of the blend from separating in the container and mixing is continued for an additional 5 minutes It is foreseen that up to about 1.0% by weight Rheolate 288 may be added, depending on the desired viscosity, which in turn may be influenced by the porosity of the surface to be coated. It is also foreseen that it may be desirable to add a quantity of a tannin stain blocking additive when the product is to be applied to the surface of a wood substrate.

### EXAMPLE 4

### Protective Surface Coating

Soy methyl esters were mixed with acrylic resin, fungicide, preservative and algaecide, titanium dioxide, calcium carbonate, mineral filler and zinc oxide to form a protective surface coating having enhanced microbial resistance. This pigmented composition can be formulated to include any color and to present a gloss, semi-gloss, satin or matte finish when cured.

| | |
|---|---|
| Soy methyl ester | 30% |
| Acrylic resin | 18% |
| Propylene glycol | 0.75% |
| Dispersant | 0.5% |
| Defoamers | 0.35% |
| solvent | 0.25% |
| Pigments/mineral filler | 38% |
| Preservative | 0.1% |
| Biocides | 0.95% |
| Thickener | 0.25%-1% |
| H₂O | 10.8% |

Materials
CSV3000™ Soy Methyl Ester based emulsion sold by PCI Group, Inc., Tempe, Ariz.
WorleeCryl® 8721 sold by Worlee-Chemie
Propylene glycol
Rhodoline 226/35 Dispersant
Colloids 622 Defoamer
Texanol Solvent
Kronos 2020 Titanium dioxide
Omyacarb #4 calcium carbonate
Minex #7 Mineral Filler
Zinc Oxide
Nuosept® 95 sold by International Specialty Products
Colloids 622 defoamer
WRACLA (Water Reducible Anti-cratering Leveling agent) Product #26 sold by PCI Group, Inc.
Fungitrol® 720 sold by International Specialty Products
Nuocide® 1075 sold by International Specialty Products
Rheolate 288 sold by Rheox, Inc.
Clean tap water

Methods

An open mixing vessel equipped with a low-shear, paddle mixer was charged with clean tap water (10% by weight). The mixer was initially set to 100-500 paddle revolutions per minute to create a mixing vortex. Propylene glycol (0.75% by weight), Rhodoline 226/35 dispersant (0.5% by weight), Colloids 622 defoamer (0.15% by weight) and Texanol solvent (0.25% by weight) were added slowly so as not to overwhelm the vortex. When the addition was completed, the mixer speed was increased to 1000 rpm and mixing continued for 5 minutes. The mixer speed was increased to 2500 rpm and the titanium dioxide (18.0% by weight), calcium carbonate (10.0% by weight) and mineral filler (7.5% by weight) and zinc oxide (2.5% by weight) were added slowly as before. The side of the mixing vessel was rinsed with a minimal amount of tap water (the volume subtracted from a total volume 0.8% by weight).

The mixture was next mixed at high speed 300 rpm until the material was smooth and free of lumps. The grind was then checked as per one or more of ASTM standards D333, D1210 and D1316 to determine that it was at least a Hegman 4. The mixer was then slowed until it produced a vortex of about 4″ to 6″ in diameter. CSV3000™ emulsion (total 30.0% by weight) was added slowly so as to avoid shock to the emulsion. This was followed by addition of WorleeCryl® 8721 Acrylic Resin (18.0% by weight). Upon completion of the addition, the emulsion was mixed at 2500 rpm for 5 minutes.

Next a premix was prepared of colloids 622 defoamer (0.2% by weight), Fungitrol® 720 (0.7% by weight), Nuosept® 95 (0.1% by weight), Nuocide® 1075 (0.25% by weight) and the remainder of 0.8% by weight clean tap water. Mixing at 2500 rpm for 20 minutes. Rheolate 288 (0.25% by weight) is next added to reduce the tendency of the blend from separating in the container. It is foreseen that up to about 1.0% by weight Rheolate 288 may be added, depending on the desired thickness, which in turn may be influenced by the porosity of the surface to be coated. It is also foreseen that it may be desirable to add a quantity of a tannin stain blocking additive when the product is to be applied to the surface of a wood substrate.

### EXAMPLE 5

### Flame Retardant Clear Sealer

Soy methyl esters were mixed with acrylic resin, biocide, preservative and a flame retardant to form a clear, flame retardant film having enhanced resistance to mold algae, mildew and other fungi.

| | |
|---|---|
| Soy Methyl Ester | 31.92% |
| Acrylic resin | 15.05% |
| Surfactant | 0.21% |
| biocide | 1.93% |
| flame retardant | 8.97% |
| Thickener | 0.25% |
| Flattening agent | 2.9% |
| Preservative | 2.0% |
| H₂O | 31.92% |
| Letdown H₂O | up to 5.1% |

Materials
CSV3000™ Soy Methyl Ester based emulsion sold by PCI Group, Inc., Tempe, Ariz.
WorleeCryl® 8721 sold by Worlee-Chemie WRACLA Product #26 (Water Reducible Anti-cratering Leveling agent) sold by PCI Group, Inc.
Polyphase 663 biocide sold by Troy Corporation
Aluminum Trihydrate flame retardant
Acusol® 820 thickening agent sold by Rohm and Haas Corp.
TS-100 flattening agent sold by Degussa Corp.
Busan 1024 in-can preservative sold by Buckman Laboratories
Clean tap water

Methods

An open mixing vessel equipped with a low-shear, paddle mixer was charged with clean tap water (31.92% by weight). Under agitation at 500 revolutions per minute, CSV 3000™ emulsion (total 31.92% by weight) was gradually poured into the vortex. WorleeCryl® 8721 Acrylic Resin (total 15.05% by weight) was next poured into the vortex and mixed for 15 minutes. WRACLA surfactant (0.21% by weight) was next added. Aluminum trihydrate (8.97% by weight) was next gradually poured into the vortex. TS-100 (2.9% by weight) was gradually added to the vortex and the speed of the blade was increased as necessary to maintain the vortex in a rolling doughnut action. Busan 1024 (2.0% by weight) was next added. Polyphase 663 (1.93% by weight) was poured into the vortex, Acusol® 820 (0.25% by weight) and a quantity of up to about 5.1% by weight of letdown water were added to achieve desired viscosity. Mixing was continued for an additional 15 minute interval.

### EXAMPLE 6

### Fungal Resistance Testing

Samples of clear sealer were prepared in accordance with Example 1 (Sample A) and were tested along with control samples of a proprietary sealer (Sample B) for fungal resistance in accordance with the American Society for Testing Materials (“ASTM”) Method D5590-94 entitled “Determining the resistance of paint films and related coatings to fungal defacement by accelerated four-week agar plate assay.” Duplicates of samples A and B were brush coated onto strips of drawn paperboard. The strips were air-dried for 24 hours. For each of A and B, one set of strips was leached with distilled water in one-gallon containers at a flow rate of six changes per day for 24 hours and dried again, while the other set remained unleached. The strips were cut into 1⅛ inch squares and placed on the surface of solidified malt agar plates. One square from each sample thus prepared was then inoculated with a mixed spore suspension of Aspergillus niger, Penicillium funiculosum, and another square was inoculated with a homogenate of Aspergillus pullulans and another square inoculated with Stachybotrys chartarum. All plates were incubated at 28° C. under 85-90% relative humidity for four weeks. Observations of growth were recorded weekly based on a scale of “0” to “10”, with “0” corresponding to complete absence of surface growth and a rating of “10” corresponding to complete coverage of the surface by fungal growth. A coating is considered resistant to fungal growth if a rating of “3” or less is attained after four weeks.

TABLE I
Four week Agar Plate Test

| | Mixed Inoculum | | A. pullulans | | S. chartarum | |
|---|---|---|---|---|---|---|
| | Unleached | leached | unleached | Leached | Unleached | Leached |
| Sam- | 1 2 3 4 | 1 2 3 4 | 1 2 3 4 | 1 2 3 4 | 1 2 3 4 | 1 2 3 4 |
| ples/ | | | | | | |
| weeks | | | | | | |
| Sample | 0 0 0 0 | 0 0 0 0 | 0 0 0 0 | 0 0 0 0 | 0 0 0 0 | 0 0 0 1 |
| A | | | | | | |
| Sample | 0 0 2 3 | 1 2 4 5 | 0 0 0 1 | 0 0 0 2 | 0 0 1 2 | 0 1 3 4 |
| B | | | | | | |

Sample A was adequately protected against fungal defacement, both before and after leaching. After leaching, the control sample was susceptible to the following fungi: A. niger, P. funiculosum and S. chartarum.

In use, the coating compositions prepared in accordance with the invention may be applied to virtually any substrate, such as concrete, concrete block wood, fiberglass, steel, cast iron, aluminum, sheetrock, plastic, fabrics such as wall coverings, and paper products such as currency. Pigmented formulations are paint-like. They may be mixed in any color and may impart a gloss, semi-gloss, satin or matte finish. Clear sealants are absorbed into the substrate, leaving a thin surface layer. Formulations for wood treatment include fire suppressant and fire retardant additives. The coating may be applied by spraying, rolling, brushing or as a pour on. Once applied, the composition is allowed to cure at ambient temperature for a period of time. Once cured, the composition exhibits microbial growth inhibition of molds, algae, mildew and other fungi, yeast, bacteria and viruses.

The composition may also be applied to currency to impart resistance to marking as well as microbial growth. For this use, the product may be diluted 1:1 with water to give a 50% concentration solution. It is foreseen that any other suitable dilution may be also be employed. The currency may be treated in a rolling bath containing the dilute composition, the currency may pass under and over jets which spray a fine mist, or the product may be by applied by dipping, rolling or brushing. The currency is next subject to heat drying. The cured coating imparts resistance to marking, inhibition of microbial growth without affecting the look, feel and usage characteristics of the currency.

It is to be understood that while certain forms of the present invention have been illustrated and described herein, it is not to be limited to the specific forms or arrangement of parts described and shown.

1. A method of treating a substrate to seal the surface and inhibit microbial growth, and comprising the steps of:
a. applying to a surface of the substrate a quantity of a coating composition including from about 30% to about 50% by weight of a soy methyl ester emulsion, from about 15% to about 25% by weight of an acrylic resin polymer solution and from about 25% to about 55% by weight of water; and
b. allowing said coating composition to cure.

2. The method of treating a substrate set forth in claim 1, wherein said soy methyl ester emulsion includes:
a. from about 4.35% to about 10.25% of methyl esters of soybean oil.

3. The method of treating a substrate set forth in claim 1, wherein said acrylic resin polymer solution includes from about 4.5% to about 7.5% of an acrylic resin.

4. The method of treating a substrate set forth in claim 1, wherein said acrylic resin polymer solution includes a cationic acrylic resin compound.

5. The method of treating a substrate set forth in claim 1, wherein said substrate is selected from the group consisting essentially of: masonry, grout, mortar and caulk, stucco, plaster, drywall, mineral board, wood, wood products, metals, synthetic resins, fiberglass, fabric, cloth, paper and asphalt.

6. The method of treating a substrate set forth in claim 1, wherein said inhibited microbial growth includes growth of microorganisms selected from the group consisting essentially of: fungi, algae, yeasts, bacteria and viruses.

7. The method of treating a substrate set forth in claim 6, wherein said fungi include molds and mildew.

8. The method of treating a substrate set forth in claim 1, wherein said substrate comprises paper currency and said method includes the additional steps of;
a. first diluting said coating composition 50% with water; and
b. following application, heating said coated currency.

9. A process for manufacturing a curable coating composition for use in sealing a substrate and inhibiting microbial activity thereon and comprising:
a. providing a quantity of a soy methyl ester emulsion;
b. providing a quantity of an acrylic resin polymer solution;
c. providing a quantity of water; and
d. mixing said emulsion, said polymer solution and said water together to form a solution, wherein said soy methyl ester is present in a concentration of about 15% to about 25% by weight, said polymer solution is present in a concentration of about 15% to about 25% by weight and said water is present in a concentration of about 25% to about 55% by weight.

10. The method set forth in claim 9 wherein said soy methyl ester emulsion includes from about 2.2% to about 3.2% of methyl esters of soybean oil.

11. The method of manufacturing a coating set forth in claim 9 wherein said acrylic resin polymer solution includes a cationic acrylic resin compound.

12. The method of manufacturing set forth in claim 9 further including the steps of:
a. providing a quantity of an additive selected from the group consisting of: preservatives, biocides, colorants, dispersants, defoamers, pigments, mineral fillers, flame retardants, surfactants, and flattening agents; and
b. mixing said additive with said emulsion, polymer solution and water.

13. In a cationic acrylic resin liquid coating composition, the improvement comprising:
a. addition of a soy methyl ester emulsion in an amount of between about 30% and 50% by weight to said liquid resin composition for inhibiting microbial growth therein and on surfaces coated therewith.

14. A coating composition for inhibiting microbial growth on a substrate and comprising:
a. from about 4.35% to about 10.25% by weight of methyl esters of soybean oil;
b. from about 15% to about 22% by weight of an acrylic resin;
c. from about 0.05% to about 0.25% of 2-amino-2-methyl-1-propanol;
d. from about 1.0% to about 3.0% by weight of water based driers;
e. from about 0.05% to about 0.10% of an emulsifier; and
f. from about 25% to about 55% by weight of water.

15. The coating composition set forth in claim 14, wherein said acrylic resin is a cationic acrylic resin.

16. The coating composition set forth in claim 14, wherein said water based driers are selected from the group consisting essentially of calcium drier, cobalt drier and zirconium drier.
